(19) United States
(12) Patent Application Publication
(10) Pub. No.: US 2017/0034585 A1
(43) Pub. Date: Feb. 2, 2017

(54) BROADCAST RECEIVING APPARATUS AND METHOD FOR PROVIDING CONTENTS RECOMMENDATION SERVICE

(71) Applicant: SAMSUNG ELECTRONICS CO., LTD., Suwon-si (KR)

(72) Inventors: Hae-min KIM, Seoul (KR); Dong-hyuk KIM, Suwon-si (KR); Hyun-jun AHN, Suwon-si (KR)

(73) Assignee: SAMSUNG ELECTRONICS CO., LTD., Suwon-si (KR)

(21) Appl. No.: 15/014,589

(22) Filed: Feb. 3, 2016

(30) Foreign Application Priority Data
Feb. 4, 2015 (KR) 10-2015-0017501
Jun. 4, 2015 (KR) 10-2015-0079422

(51) Int. Cl. H04N 21/482

(52) U.S. Cl. CPC H04N 21/4826; H04N 21/4828

(57) ABSTRACT

A broadcast receiving apparatus and method for providing a contents recommendation service are provided. The method for providing a contents recommendation service of a broadcast receiving apparatus includes: displaying image contents; searching a plurality of associated contents associated with the image contents, according to a user instruction; aligning the plurality of associated contents based on at least one of image quality information and broadcast time information of the plurality of associated contents; and displaying a contents list for the plurality of associated contents which are aligned. Therefore, the broadcast receiving apparatus may provide various digital broadcast services to a user.

### CROSS-REFERENCE TO RELATED APPLICATIONS

This application claims priority from Korean Patent Application No. 10-2015-0017501, filed on Feb. 4, 2015 and Korean Patent Application No. 10-2015-0079422, filed on Jun. 4, 2015, in the Korean Intellectual Property Office, the disclosure of which are incorporated herein by reference in its entirety.

### BACKGROUND

1. Field

Apparatuses and methods consistent with the embodiments relate to a broadcast receiving apparatus and method for providing a contents recommendation service, and more particularly, to a broadcast receiving apparatus and method for providing a contents recommendation service providing a plurality of associated contents associated with image contents selected by a user.

2. Description of the Related Art

A digital broadcast service recently provides various genres of image contents through a plurality of channels. Accordingly, a user may select a specific channel among the plurality of channels to receive his or her favorite image contents. However, as various image contents are provided through the plurality of channels, it is difficult for some users to select a channel providing his or her favorite image contents.

In order to solve the above-mentioned problem, an electronic program guide (EPG) information service providing information on the image contents for each of the plurality of channels is provided. Accordingly, the user may easily check program information provided from the plurality of channels using the EPG information service and may select a channel providing the image contents that he or she desires.

As well, the digital broadcast service searches only program information on a user's favorite channel among the plurality of channels using EPG information to provide the program information, or groups the channels into each genre to provide the grouped channel. Accordingly, the user may more easily check the program information of his or her favorite channel and may more rapidly perform a channel change to the corresponding channel.

The digital broadcast service according to the related art as described above is mostly associated with a service searching and providing a channel providing user's favorite image contents among the plurality of channels or a channel providing contents associated with image contents which are being currently watched, but does not provide various services, for example, providing information on a channel providing image contents having excellent image quality among the searched channels, and the like.

### SUMMARY

Additional aspects and/or advantages will be set forth in part in the description which follows and, in part, will be apparent from the description, or may be learned by practice of the embodiments.

Exemplary embodiments overcome the above disadvantages and other disadvantages not described above. Also, the embodiments are not required to overcome the disadvantages described above, and an exemplary embodiment may not overcome any of the problems described above.

The embodiments provide various digital broadcast services to a user.

Further, the embodiments increase convenience for a selection of a channel providing associated contents associated with image contents which are being currently displayed.

According to an aspect, a method for providing a contents recommendation service of a broadcast receiving apparatus includes: displaying image contents; searching a plurality of associated contents associated with the image contents, according to a user instruction; aligning the plurality of associated contents based on at least one of image quality information and broadcast time information of the plurality of associated contents; and displaying a contents list for the plurality of associated contents which are aligned.

In the operation of aligning the plurality of associated contents, in the case in which an alignment condition is an alignment condition for image quality, the plurality of associated contents may be aligned in the order of the associated contents of high image quality based on the image quality information of the associated contents.

In the operation of aligning the plurality of associated contents, in the case in which an alignment condition is an alignment condition for a broadcast time, the plurality of associated contents may be aligned in the order of the associated contents having an earlier reproduction time than a current reproduction time of the image contents based on the broadcast time information of the associated contents.

In the operation of aligning the plurality of associated contents, in the case in which first associated contents among the plurality of associated contents are being reproduced, the first associated contents may be determined as the top priority when a total reproduction time in which the first associated contents are reproduced is within a preset reference time.

In the operation of aligning the plurality of associated contents, in the case in which an alignment condition is a complex alignment condition, the plurality of associated contents may be aligned in the order of the associated contents of high image quality based on the image quality information, and the associated contents included in a preset priority may be realigned based on the broadcast time information of the associated contents included in the preset priority among the plurality of associated contents which are aligned.

In the operation of aligning the plurality of associated contents, in the case in which the image contents are a serial type of contents, the associated contents included in the same group as the image contents among the plurality of associated contents may be searched, and if the associated contents included in the same group as the image contents are searched, the plurality of associated contents may be aligned in the order of the associated contents included in the same group as the image contents, and if the associated contents included in the same group as the image contents are not searched, the plurality of associated contents may be aligned in the order of the associated contents belonging to an upper group or a lower group on the basis of the group including the image contents.

In the operation of aligning the plurality of associated contents, the plurality of associated contents which are aligned may be realigned based on organization type information of the plurality of associated contents, and the organization type information may include at least one of a live broadcast, an original air, and a rerun.

In the operation of aligning the plurality of associated contents, the plurality of associated contents may be aligned based on at least one of the image quality information and the broadcast time information of the rest of the plurality of associated contents except for associated contents which are set to a pay service, among the plurality of associated contents.

The contents list may include thumbnail images for identifying each of the plurality of associated contents which are aligned, and the thumbnail images may include at least one of the image quality information, the broadcast time information, title information, episode information, channel information, and pay information of the associated contents.

The method may further include executing associated contents corresponding to a selected thumbnail image when one of a plurality of thumbnail images included in the contents list is selected, wherein in the operation of executing the associated contents, a broadcast time of the associated contents corresponding to the selected thumbnail image may be compared with a current time to determine whether or not the associated contents corresponding to the selected thumbnail image are watchable, if the associated contents corresponding to the selected thumbnail image are watchable, a channel change to a channel of the associated contents corresponding to the selected thumbnail image may be performed, and if the associated contents corresponding to the selected thumbnail image are not watchable, at least one of a reservation watch and a reservation record for the associated contents corresponding to the selected thumbnail image may be executed based on the user instruction.

According to another aspect, a broadcast receiving apparatus includes: a display unit configured to display image contents: and a controlling unit configured to control the display unit so that a plurality of associated contents associated with the image contents are searched according to a user instruction, the plurality of associated contents are aligned based on at least one of image quality information and broadcast time information of the plurality of associated contents which are searched, and a contents list for the plurality of associated contents which are aligned is displayed.

In the case in which an alignment condition is an alignment condition for image quality, the controlling unit may align the plurality of associated contents in the order of the associated contents of high image quality based on the image quality information of the associated contents.

In the case in which an alignment condition is an alignment condition for broadcast time, the controlling unit may align the plurality of associated contents in the order of the associated contents having an earlier reproduction time than a current reproduction time of the image contents based on the broadcast time information of the associated contents.

In the case in which first associated contents among the plurality of associated contents are being reproduced, the controlling unit may determine the first associated contents as the top priority when a total reproduction time in which the first associated contents are reproduced is within a preset reference time.

In the case in which an alignment condition is a complex alignment condition, the controlling unit may align the plurality of associated contents in the order of the associated contents of high image quality based on the image quality information and realign the associated contents included in a preset priority based on the broadcast time information of the associated contents included in the preset priority among the plurality of associated contents which are aligned.

In the case in which the image contents are a serial type of contents, the controlling unit may search the associated contents included in the same group as the image contents among the plurality of associated contents and align the plurality of associated contents in the order of the associated contents included in the same group as the image contents if the associated contents belonging to the same group as the image contents are searched, and may align the plurality of associated contents in the order of the associated contents belonging to an upper group or a lower group on the basis of the group including the image contents if the associated contents included in the same group as the image contents are not searched.

The controlling unit may realign the plurality of associated contents which are aligned, based on organization type information of the plurality of associated contents, and the organization type information may include at least one of a live broadcast, an original air, and a rerun.

The controlling unit may align the plurality of associated contents based on at least one of the image quality information and the broadcast time information of the rest of the plurality of associated contents except for associated contents which are set to a pay service, among the plurality of associated contents.

The contents list may include thumbnail images for identifying each of the plurality of associated contents which are aligned, and the thumbnail images may include at least one of the image quality information, the broadcast time information, title information, episode information, channel information, and pay information of the associated contents.

The controlling unit may compare a broadcast time of the associated contents corresponding to the selected thumbnail image with a current time when one of a plurality of thumbnail images included in the contents list is selected to determine whether or not the associated contents corresponding to the selected thumbnail image are watchable, may perform a channel change to a channel of the associated contents corresponding to the selected thumbnail image, if the associated contents corresponding to the selected thumbnail image are watchable, and may execute at least one of a reservation watch and a reservation record for the associated contents corresponding to the selected thumbnail image based on the user instruction, if the associated contents corresponding to the selected thumbnail image are not watchable.

According to another aspect an apparatus includes a display, and a computer searching image contents for similar contents with similar characteristics, sorting the image contents for the similar contents using the similar characteristics; displaying the image contents with the similar contents aligned one of vertically and horizontally.

The similar characteristics may include one of image quality, broadcast time, time order, image channel.

The image contents may be represented by thumbnail images.

The image contents may have associated image contents with sub-characteristics and when one of the thumbnail images is selected by a user corresponding associated image contents may be displayed on the display ordered by the sub-characteristics.

The image contents and associated image contents may be arranged in 2 dimensions.

The thumbnail image contents may be arranged as a visual program guide of image broadcasts.

When the user selects one of the thumbnail images an image channel may changed to a channel corresponding to a thumbnail image selected.

As described above, according to an exemplary embodiment, a broadcast receiving apparatus may provide a user with various digital broadcast services. In addition, a broadcast receiving apparatus according to an exemplary embodiment may enhance user convenience in selecting channels providing contents related to an image content which is current being displayed.

### BRIEF DESCRIPTION OF THE DRAWINGS

The above and/or other aspects will be more apparent by describing certain exemplary embodiments with reference to the accompanying drawings, in which:

FIG. 1 is a block diagram of a broadcast receiving apparatus according to an exemplary embodiment;

FIG. 2 is a detailed block diagram of the broadcast receiving apparatus according to the exemplary embodiment;

FIG. 3 is a diagram illustrating a case in which contents lists for a plurality of associated contents associated with image contents are displayed in the broadcast receiving apparatus according to the exemplary embodiment;

FIG. 4 is a diagram illustrating a thumbnail image identifying associated contents according to an exemplary embodiment;

FIGS. 5A and 5B are diagrams illustrating a case in which a plurality of associated contents are aligned according to an image quality alignment condition in the broadcast receiving apparatus according to the exemplary embodiment;

FIGS. 6A and 6B are diagrams illustrating a case in which the plurality of associated contents are aligned according to an alignment condition for a broadcast time in the broadcast receiving apparatus according to the exemplary embodiment;

FIGS. 7A and 7B are diagrams illustrating a case in which a plurality of associated contents are aligned according to a complex alignment condition in the broadcast receiving apparatus according to the exemplary embodiment;

FIGS. 8A and 8B are first illustrative diagrams illustrating a case in which a plurality of associated contents associated with image contents of a serial form are aligned in the broadcast receiving apparatus according to the exemplary embodiment;

FIGS. 9A and 9B are second illustrative diagrams illustrating a case in which a plurality of associated contents associated with image contents of a serial form are aligned in a broadcast receiving apparatus according to another exemplary embodiment;

FIGS. 10A and 10B are diagrams illustrating a case in which the plurality of associated contents are aligned according to an organization type condition in the broadcast receiving apparatus according to the exemplary embodiment;

FIG. 11 is a flow chart of a method for providing a contents recommendation service in a broadcast receiving apparatus according to an exemplary embodiment;

FIG. 12 is a flow chart of a method for aligning a plurality of associated contents which are pre-searched in a broadcast receiving apparatus according to an exemplary embodiment; and

FIG. 13 is a flow chart of a method for aligning a plurality of associated contents which are pre-searched according to a time alignment condition in the broadcast receiving apparatus according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the embodiments by referring to the figures.

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

The terms “first”, “second”, etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, exemplary embodiments will be described in more detail with reference to the accompanying drawings.

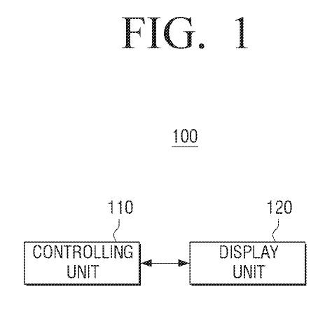

FIG. 1 is a block diagram of a broadcast receiving apparatus according to an exemplary embodiment.

As illustrated in FIG. 1, a broadcast receiving apparatus 100, which is a terminal capable of receiving image contents provided from a server (not illustrated) providing the image contents, may be, for example, a display apparatus such as a smart TV, a smart phone, a table PC, or the like, or a set-top box outputting the image contents provided from the server (not illustrated) providing the image contents to the terminal such as the smart TV, or the like.

The broadcast receiving apparatus 100 described above includes a controlling unit 110 and a display unit 120. The controlling unit 110 generally controls operations of the respective components configuring the broadcast receiving apparatus 100. Particularly, the controlling unit 110 searches a plurality of associated contents associated with image contents which are being displayed, according to a user instruction. Thereafter, the controlling unit 110 aligns the plurality of associated contents based on at least one of image quality information and broadcast time information of the plurality of associated contents searched with regard to the image contents. Thereafter, the controlling unit 110, which may be a computer or a processor, controls the display unit 120 so that a contents list for the plurality of associated contents which are aligned is generated and the generated contents list is displayed.

The display unit 120 displays image contents requested by a user according to a control instruction of the controlling unit 110. The above-mentioned image contents may be at least one of contents provided from a channel selected according to a user request, contents supplied by a video on demand (VOD) operator, contents pre-stored in the broadcast receiving apparatus 100, and contents received from other terminals. As well, the display unit 110 displays a contents list for the image contents requested by the user and a plurality of associated contents associated with the corresponding image contents, according to the control instruction of the controlling unit 110.

The above-mentioned display unit 120 may be implemented as a touch screen capable of sensing a touch, a cathode ray tube (CRT), a liquid crystal display (LCD), a thin film transistor liquid crystal display (TFT-LCD), a plasma display panel (PDP), a flexible display, a head mounted display (HMD), or the like.

Specifically, in a state in which the image contents requested by the user are displayed by the display unit 120, the controlling unit 110 may receive a contents search service related user instruction. In the case in which the above-mentioned contents search service related user instruction is received, the controlling unit 110 searches associated contents associated with image contents which are being currently displayed, based on image quality information and broadcast time information included in pre-stored contents information for each of a plurality of channels. Here, the contents information, which is an electronic program guide (EPG), may include at least one of image quality information and broadcast time information for image contents provided to each of the channels as well as title information, episode information, channel information, and pay information of the corresponding image contents.

Therefore, in the case in which the contents search service related user instruction is input, the controlling unit 110 may search a plurality of associated contents associated with image contents which are being displayed, using various information included in the contents information. Here, the plurality of associated contents searched with regard to the image contents may be contents which are equal to the corresponding image contents and have different resolution. However, the embodiment is not limited thereto. In the case in which the image contents are serial type of contents, the plurality of associated contents searched with regard to the image contents may be the contents which are equal to the corresponding image contents and have different resolution, contents belonging to the same group as the corresponding image contents and having different resolution, or contents belonging to another group associated with the same group and having different resolution.

For example, in the case in which the image contents are a series type of contents, the plurality of associated contents searched with regard to the image contents may be contents present in the corresponding series. As another example, in the case in which the image contents are a seasonal type of contents, the plurality of associated contents searched with regard to the image contents may be contents belonging to the same season as the image contents, and in the case in which there are successive seasons, the plurality of associated contents searched with regard to the image contents may be contents present in the successive seasons.

As such, in the case in which the plurality of associated contents for the image contents which are being displayed are searched, the controlling unit 110 may align the plurality of associated contents based on at least one of the image quality information and the broadcast time information included in the contents information of each of the plurality of associated contents which are searched and may generate the contents list for the plurality of associated contents which are aligned. Hereinafter, a method for aligning a plurality of associated contents pre-searched with regard to the image contents will be described in detail with reference to various exemplary embodiments.

According to an exemplary embodiment, in the case in which an alignment condition for image quality is preset, the controlling unit 110 may align the plurality of associated contents in the order of high image quality, based on image quality information of the plurality of associated contents pre-searched with regard to the image contents. In general, the contents provided over the digital broadcast service may be largely classified into standard definition (SD), high definition (HD), and an ultra high definition (UHD). Since SD has a pixel of 720*480, HD has a pixel of 1920*1080, and UHD has a pixel of 7680*4320, a high image quality digital image is provided in the order of SD, HD, and UHD.

Therefore, the controlling unit 110 may sequentially align the plurality of associated contents from the associated contents having the most excellent image quality using image quality information on each of the plurality of associated contents. For example, first associated contents searched with regard to the image contents may support an image with UHD image quality, second associated contents may support an image with HD image quality, and third associated contents may support an image with SD image quality. In this case, the controlling unit 110 may sequentially align the plurality of associated contents from the first associated contents having the most excellent image quality.

However, the embodiment is not limited thereto, and the image quality information described above may be one of depth information and screen ratio information. In this case, the controlling unit 110 may align the plurality of associated contents in the order of the associated contents having the excellent image quality based on the depth information or the screen ratio information of the plurality of associated contents.

According to another exemplary embodiment, in the case in which an alignment condition for a broadcast time is preset, the controlling unit 110 may align the plurality of associated contents in the order of the associated contents having a fast reproduction time on the basis of a current reproduction time of the image contents which are being currently displayed, based on broadcast time information of the plurality of associated contents pre-searched with regard to the image contents.

For example, the first associated contents searched with regard to the image contents may be provided at 9 A.M, and the second and third associated contents may be provided at 3 P.M and 4 P.M, respectively. In this case, the controlling unit 110 may sequentially align the plurality of associated contents from the first associated contents having the fastest reproduction time.

Meanwhile, the controlling unit 110 may determine the first associated contents as top priority depending on whether or not a total of reproduction time in which the first associated contents are reproduced is within a preset reference time range, in the case in which the first associated contents among the plurality of associated contents are being reproduced in aligning the plurality of associated contents based on the broadcast time information of the plurality of associated contents.

For example, the preset reference time may be ten minutes. In this case, the controlling unit 110 may determine the first associated contents as the top priority, in the case in which a reproduced time of the first associated contents which are being currently reproduced is the preset reference time or less. Meanwhile, in the case in which the reproduced time of the first associated contents which are being currently reproduced exceeds the preset reference time, the controlling unit 110 may determine the first associated contents as the lowest priority, or may align the plurality of associated contents based on the broadcast time information of other associated contents except for the first associated contents.

However, the embodiment is not limited thereto, but the controlling unit 110 may compare the reproduction time of the first associated contents which are being currently reproduced among the plurality of associated contents with a total of reproduction time in which the image contents which are being currently reproduced are reproduced, and may determine the first associated contents as the top priority depending on the comparison result. Specifically, in the case in which it is determined that the first associated contents which are being currently reproduced are reproduced at the same timing as the image contents or are reproduced at a timing later than the image contents, the controlling unit 110 determines the first associated contents as the top priority. Meanwhile, in the case in which it is determined that the first associated contents which are being currently reproduced are reproduced at a timing earlier than the corresponding image contents, the controlling unit 110 may determine the first associated contents as the lowest priority, or may align the plurality of associated contents based on the broadcast time information of other associated contents except for the first associated contents.

Meanwhile, the alignment condition for the broadcast time may include at least one lower alignment condition of an episode alignment condition, an organization type alignment condition, and a provision source alignment condition.

In the case in which the alignment condition for the broadcast time is the episode alignment condition, the controlling unit 110 determines whether or not the image contents which are being displayed are a seasonal type of contents. As the determination result, in the case in which it is determined that the image contents which are being displayed are contents for each of the episodes and are not the seasonal type of contents, the controlling unit 110 aligns the associated contents for each of the episodes based on the image contents which are being displayed.

According to an exemplary embodiment, in the case in which it is determined that the image contents which are being displayed are contents for each of the episodes and are not the seasonal type of contents, the controlling unit 110 may align the plurality of associated contents in the order of a low episode based on episode information corresponding to each of the plurality of associated contents.

According to another exemplary embodiment, in the case in which it is determined that the image contents which are being displayed are contents for each of the episodes and are not the seasonal type of contents, the controlling unit 110 may align the plurality of associated contents by determining the associated contents of the same episode as the image contents as the top priority based on episode information corresponding to the image contents and the plurality of associated contents which are pre-searched, respectively, and determining the associated contents belonging to a low episode among other associated contents as a next priority.

Meanwhile, in the case in which the image contents are a serial type of contents such as a season, the controlling unit 110 determines whether or not the plurality of associated contents pre-searched with regard to the image contents belong to the same season as the image contents. As the determination result, in the case in which it is determined that the plurality of associated contents belong to the same season as the image contents, the controlling unit 110 aligns the plurality of associated contents in the order of the low episode based on the episode information corresponding to each of the plurality of associated contents pre-searched with regard to the image contents.

Meanwhile, in the case in which it is determined that the plurality of associated contents pre-searched with regard to the image contents belong to a different season from the image contents, the controlling unit 110 aligns the plurality of associated contents in the order of the associated contents belonging to a season which is adjacent to the season to which the image contents belong, among the plurality of associated contents.

However, the embodiment is not limited thereto. For example, at least one of the plurality of associated contents pre-searched with regard to the image contents may belong to the same season as the image contents, and the rest of the plurality of associated contents may belong to the different season from the image contents. In this case, the controlling unit 110 may align the plurality of associated contents by determining the associated contents belonging to the same season as the image contents as the top priority and determining the associated contents belonging to the season which is adjacent to the season to which the image contents belong, among the rest of the associated contents as the next priority.

Meanwhile, in the case in which the alignment condition for the broadcast time is the organization type alignment condition, the controlling unit 110 aligns the plurality of associated contents based on organization type information corresponding to each of the plurality of associated contents pre-searched with regard to the image contents.

According to the exemplary embodiment, the controlling unit 110 may realign the plurality of associated contents which are pre-aligned, based on the organization type information of the plurality of associated contents. Here, the organization information may include at least one of a live broadcast, an original air, and a rerun. For example, in a state in which the plurality of associated contents are aligned in the order of the first, second, and third associated contents, the first and second associated contents may be contents provided as the rerun, and the third associated contents may be contents provided as the original air. In this case, the controlling unit 110 may determine the third associated contents, which are the original air, as the top priority, and may realign the plurality of associated contents in the order of the third, first, and second associated contents based on the above-mentioned determination.

Meanwhile, in the case in which a lower alignment condition which is currently set among a plurality of lower alignment conditions associated with the time alignment condition is the provision source alignment condition, the controlling unit 110 aligns the plurality of associated contents pre-searched with regard to the image contents based on user preference.

For example, in the case in which associated contents which are set to a pay service are present in the plurality of associated contents pre-searched with regard to the image contents which are being currently displayed, the controlling unit 110 may align the plurality of associated contents based on at least one of the image quality information and the broadcast time information of the rest of the plurality of associated contents except for the associated contents which are set to the pay service among the plurality of associated contents.

As another example, the controlling unit 110 may align the plurality of associated contents in the order of the associated contents of a favorite watching channel of the user among the plurality of associated contents pre-searched with regard to the image contents which are being displayed, according to the provision source alignment condition.

According to another exemplary embodiment, in the case in which a complex alignment condition for image quality and broadcast time is preset, the controlling unit 110 may align the plurality of associated contents in the order of the associated contents of high image quality, based on image quality information on each of the plurality of associated contents pre-searched with regard to the image contents which are being displayed. Thereafter, the controlling unit 110 may realign the associated contents included in a preset priority based on broadcast time information of the associated contents included in the preset priority among the plurality of associated contents which are aligned in the order of the high image quality.

According to another exemplary embodiment, the controlling unit 110 may align the plurality of associated contents pre-searched with regard to the image contents depending on whether or not the corresponding image contents which are being currently displayed are the serial type contents.

Specifically, in the case in which the image contents which are being currently displayed are the serial type contents such as a series or season, the controlling unit 110 searches the associated contents included in the same group as the image contents which are being displayed among the plurality of associated contents. As the search result, in the case in which the associated contents included in the same group as the corresponding image contents are searched, the controlling unit 110 aligns the plurality of associated contents in the order of the associated contents included in the same group as the image contents. Meanwhile, in the case in which the associated contents included in the same group as the corresponding image contents are not searched, the controlling unit 110 aligns the plurality of associated contents in the order of the associated contents belonging to an upper group or a lower group on the basis of the group including the image contents.

Meanwhile, the controlling unit 110 may realign the plurality of associated contents which are aligned according to the various exemplary embodiments described above. According to the exemplary embodiment, the controlling unit 110 may realign the plurality of associated contents which are pre-aligned, based on the organization type information of the plurality of associated contents. Here, the organization type information may include at least one of a live broadcast, an original air, and a rerun. For example, in a state in which the plurality of associated contents are aligned in the order of the first, second, and third associated contents, the first and second associated contents may be contents provided as the rerun, and the third associated contents may be contents provided as the original air. In this case, the controlling unit 110 may determine the third associated contents, which are the original air, as the top priority, and may realign the plurality of associated contents in the order of the third, first, and second associated contents based on the above-mentioned determination.

Meanwhile, in the case in which associated contents which are set to a pay service are present in the plurality of associated contents pre-searched with regard to the image contents which are being currently displayed, the controlling unit 110 may align the plurality of associated contents based on at least one of the image quality information and the broadcast time information of the rest of the plurality of associated contents except for the associated contents which are set to the pay service among the plurality of associated contents.

In the case in which the plurality of associated contents pre-searched with regard to the image contents which are being currently displayed are aligned by the various alignment conditions described above, the controlling unit 110 generates a contents list for the plurality of associated contents which are aligned. Here, the contents list includes thumbnail images for identifying each of the plurality of associated contents aligned by the various alignment conditions described above. The above-mentioned thumbnail images may include at least one of image quality information, broadcast time information, title information, episode information, channel information, and pay information for each of the plurality of associated contents. Therefore, the display unit 120 may display the contents list including the thumbnail images corresponding to each of the plurality of associated contents associated with the image contents which are being currently displayed, on one region of a screen.

Meanwhile, in a state in which the contents list is displayed, if one of a plurality of thumbnail images included in the contents list is selected, the controlling unit 110 executes the associated contents corresponding to the selected thumbnail image.

Specifically, in the case in which one thumbnail image is selected, the controlling unit 110 compares a broadcast time of the associated contents corresponding to the selected thumbnail image with a current time to determine whether or not the associated contents corresponding to the selected thumbnail image may be watched. As the determination result, in the case in which the associated contents corresponding to the selected thumbnail image may be watched, the controlling unit 110 performs a channel change to a channel of the associated contents corresponding to the selected thumbnail image. Therefore, the display unit 120 may display the associated contents corresponding to the thumbnail image selected by the user.

Meanwhile, in the case in which the associated contents corresponding to the selected thumbnail image may not be watched, the controlling unit 110 may execute at least one of a reservation watch and a reservation record for the associated contents corresponding to a pre-selected thumbnail image based on a user instruction. Specifically, the associated contents corresponding to the selected thumbnail image may be a broadcast schedule contents provided at a time later than a current time. In this case, the controlling unit 110 controls the display unit 120 so that a pop-up message guiding that the associated contents corresponding to the selected thumbnail image are the broadcast schedule contents is generated and the generated pop-up message is displayed. Therefore, the display unit 120 may display the pop-up message guiding that the associated contents corresponding to the selected thumbnail image are the broadcast schedule contents. If an execution instruction for the corresponding associated contents is input in a state in which the above-mentioned pop-up message is displayed, the controlling unit 110 may perform at least one of the watching reservation and the reservation record for the associated contents, which are the broadcast schedule contents, based on the input execution instruction.

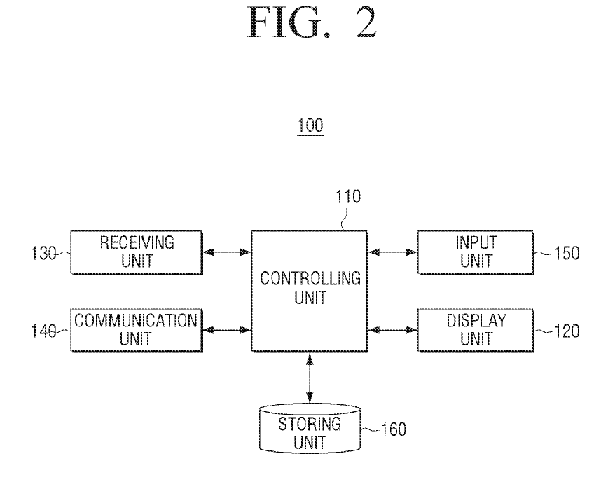

FIG. 2 is a detailed block diagram of the broadcast receiving apparatus according to the exemplary embodiment.

As illustrated in FIG. 2, the broadcast receiving apparatus 100 may further include a receiving unit 130, a communication unit 140, an input unit 150, and a storing unit 160, in addition to the controlling unit 110 and the display unit 120 described above.

The receiving unit 130 receives contents from at least one of a radio wave, a satellite, and a cable by a tuner unit (not illustrated). Specifically, the receiving unit 130 may select a channel corresponding to a user instruction using prestored contents information by the tuner unit (not illustrated) and receive contents requested by the user through the selected channel. In the case in which the above-mentioned contents are received, the controlling unit 110 performs a signal processing for image and audio data included in the received contents into an outputable form. Therefore, the display unit 120 may display image contents for the corresponding contents which are signal-processed to the outputable form on a screen, and an audio output unit (not illustrated) may output audio data for the corresponding contents which are signal-processed to the outputable form in an audible sound form.

The communication unit 140 may receive the contents requested by the user by performing wire or wireless communication with a contents server (not illustrated) providing the contents or receive the user instruction by performing communication with a remote controller (not illustrated) controlling an operation of the broadcast receiving apparatus 100. Specifically, the communication unit 140 may receive various user instructions such as an operation control instruction, a channel select instruction, a contents search instruction, and the like, of the broadcast receiving apparatus 100 through the remote controller (not illustrated).

Such communication unit 140 may include various communication modules such as a local area wireless communication module (not illustrated), a wireless communication module (not illustrated), and the like. Here, the local area wireless communication module is a module for performing wireless communication with external apparatuses such as a contents server (not illustrated), a user terminal (not illustrated), and the like, according to a local area wireless communication scheme such as Bluetooth scheme, Zigbee, and the like. In addition, the wireless communication module is a module connected to an external network according to a wireless communication protocol such as WiFi, IEEE, or the like, to perform communication. Besides, the wireless communication module may further include a mobile communication module connected to a mobile communication network according to various mobile communication standards such as 3rd generation (3G), 3rd generation partnership project (3GPP), Long Term Evolution (LTE), and the like, and performing communication.

The input unit 150 receives the user instruction received from an input means such as an manipulation unit (not illustrated) or a touch panel (not illustrated) included in the broadcast receiving apparatus 100 and transfers the user instruction to the controlling unit 110. Here, the user instruction may be an operation control instruction, a channel select instruction, a contents search instruction, or the like, of the broadcast receiving apparatus 100. The above-mentioned input unit 150 may include a voice recognition module (not illustrated) capable of recognizing voice of the user. In this case, the input unit 150 may recognize user voices for various user instructions such as a broadcast channel select instruction, an abstract contents generation instruction, an abstract contents reproduction instruction, and the like, through the voice recognition module (not illustrated) and may transfer the recognized voice recognition result to the controlling unit 110.

The storing unit 160, which is a record medium in which a variety of programs necessary to operate the broadcast receiving apparatus 100 are stored, may be implemented by a memory, a hard disk drive (HDD), and the like. For example, the storing unit 160 may include a read only memory (ROM) for storing a program for executing an operation of the controlling unit 110, a random access memory (RAM) for temporarily storing data according to the operation execution of the controlling unit 110, and the like. As well, the storing unit 160 may further include an electrical erasable and programmable ROM (EEPROM) for storing a variety of reference data.

The above-mentioned storing unit 160 may store the contents information on the contents provided from each of the plurality of channels, and recorded contents, as described above. Here, the contents information, which is an electronic program guide (EPG), may include at least one of image quality information and broadcast time information for image contents provided to each of the channel as well as title information, episode information, channel information, and pay information of the corresponding image contents.

Hereinafter, the contents list for the plurality of associated contents associated with the image contents which are being currently displayed on the broadcast receiving apparatus 100, and an operation of aligning the plurality of associated contents will be described in detail.

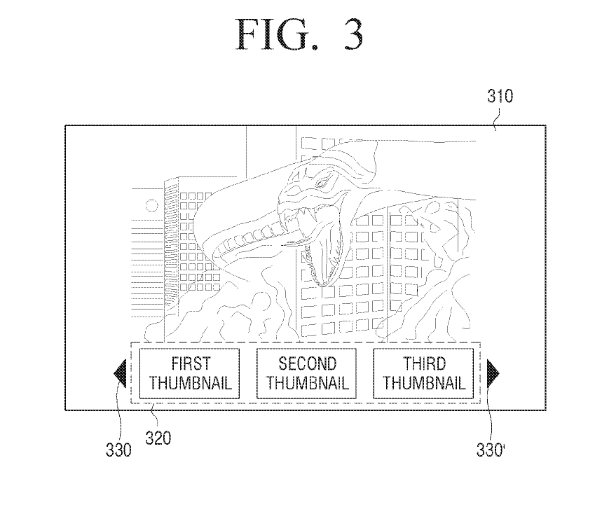

FIG. 3 is a diagram illustrating a case in which the contents lists for the plurality of associated contents associated with the image contents are displayed on the broadcast receiving apparatus according to the exemplary embodiment.

As illustrated in FIG. 3, the broadcast receiving apparatus 100 may display image contents 310 provided from a channel requested by the user through the display unit 120. In a state in which the above-mentioned image contents 310 are displayed, if a user instruction for a contents search service is input, the controlling unit 110 searches the plurality of associated contents associated with the image contents 310 based on prestored contents information. Thereafter, the controlling unit 110 aligns the plurality of associated contents which are searched, based on the preset condition and generates the contents list for the plurality of associated contents which are aligned. In the case in which the above-mentioned contents list is displayed, the display unit 120 displays a contents list 320 on one region of a screen on which the image contents 310 are displayed.

As illustrated, the display unit 120 may display the contents list 320 including thumbnail images (hereinafter, refer to first to third thumbnails) corresponding to each of first to third associated contents searched with regard to the image contents 310 on a lower end portion of the screen. Here, the first to third thumbnails included in the contents list 320 may be identification items corresponding to each of the first to third associated contents aligned according to preset alignment conditions. For example, in the case in which the first to third associated contents are aligned according to an alignment condition corresponding to a first category, the contents list 320 may include the first to third thumbnails corresponding to each of the first to third associated contents. Meanwhile, in the case in which the first to third associated contents are aligned according to alignment conditions corresponding to first and second categories, the contents list 320 may include the first to third thumbnails for each of the first and second categories. That is, the contents list 320 may include the first to third thumbnails for the first to third associated contents aligned according to the alignment condition corresponding to the first category, and the first to third thumbnails for the first to third associated contents aligned according to the alignment conditions to correspond to the second category.

Further, the display unit 120 may display the contents list 320 and movement icons 330 and 330′ for selecting the first to third thumbnails included in the contents list 320 at both sides of the contents list 320. Therefore, the user may select one of the first to third thumbnails included in the contents list 320 or select one of the first to third thumbnails by moving a cursor using the movement icons 330 and 330′.

Hereinafter, the thumbnail images included in the contents list will be described in more detail.

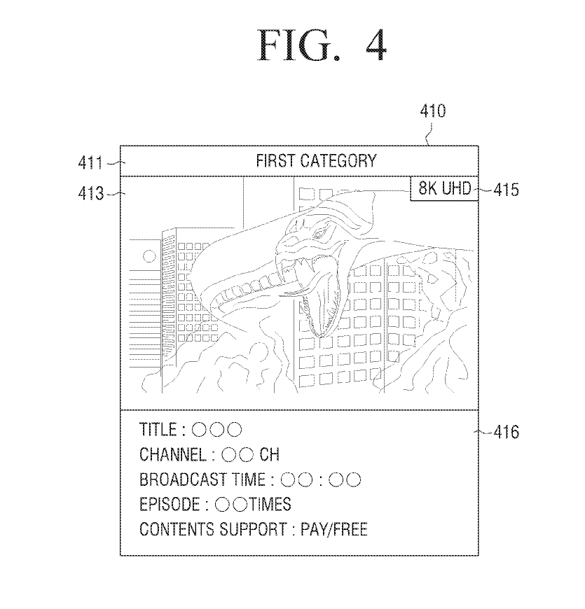

FIG. 4 is a diagram illustrating a thumbnail image identifying associated contents according to an exemplary embodiment.

As described above, the controlling unit 110 aligns the plurality of associated contents searched with regard to the image contents which are being currently displayed, according to the preset alignment condition, and generates the contents list for the plurality of associated contents which are aligned. Therefore, the display unit 120 may display the contents list including the thumbnail images corresponding to each of the plurality of associated contents which are aligned on one region of the screen, and the user may watch his or her desired associated contents through the thumbnail images included in the contents list.

The above-mentioned thumbnail images may include at least one of alignment condition information, image quality information, title information, channel information, broadcast time information, episode information, and pay information.

According to the exemplary embodiment, the plurality of associated contents searched with regard to the image contents which are being displayed may be aligned according to the alignment condition corresponding to the first category. Here, the alignment condition corresponding to the first category may be at least one of an image quality condition and a broadcast time condition. For example, in the case in which the alignment condition corresponding to the first category is the image quality condition, as illustrated in FIG. 4, a thumbnail image 410 includes at least one of alignment condition information 411 guiding that the plurality of associated contents are aligned according to the first category corresponding to the image quality condition, identification information 413 for identifying the associated contents corresponding to the corresponding thumbnail image 410, image quality information 415 indicating image quality of the associated contents, and additional information 416 for the associated contents. Here, the additional information 416 may include at least one of title information, channel information, broadcast time information, episode information, and pay information of the associated contents.

Therefore, the user may determine whether he or she watches the associated contents corresponding to the thumbnail image 410, with reference to at least one of the alignment condition information 411, the identification information 413, the image quality information 415, and the additional information 416 included in the above-mentioned thumbnail image 410.

Hereinafter, an operation of aligning the plurality of associated contents searched with regard to the image contents which are being currently displayed will be described in detail.

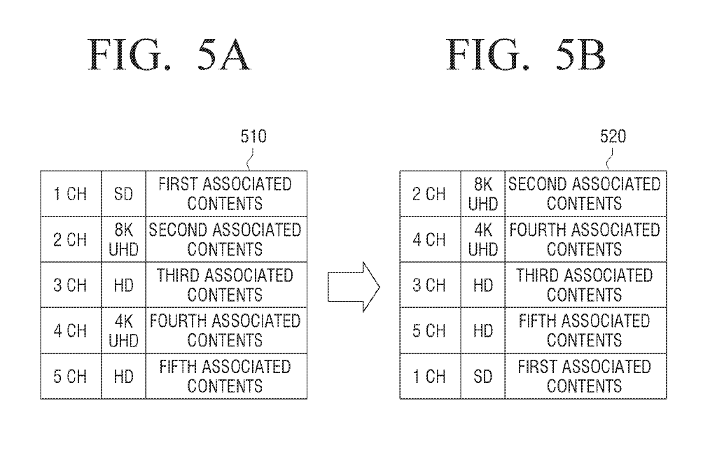

FIGS. 5A and 5B are diagrams illustrating a case in which the plurality of associated contents are aligned according to the image quality alignment condition in the broadcast receiving apparatus according to the exemplary embodiment.

An alignment list 510 illustrated in FIG. 5A illustrates a case in which first to fifth associated contents searched with regard to the image contents which are being currently displayed are sequentially aligned from an upper channel, and an alignment list 520 illustrated in FIG. 5B illustrates a case in which the first to fifth associated contents are aligned according to the image quality alignment condition corresponding to the first category.

Specifically, the controlling unit 110 may search the first to fifth associated contents searched with regard to the image contents which are being currently displayed as contents associated with the image contents. Meanwhile, in the case in which the alignment condition is the image quality alignment condition corresponding to the first category, the controlling unit 110 aligns the first to fifth associated contents based on image quality information of the first to fifth associated contents which are searched.

For example, the first associated contents may support an image with SD image quality, the second associated contents may support an image with 8K UHD image quality, the third and fifth associated contents may support an image with HD image quality, and the fourth associated contents may support an image with 4K UHD image quality.

In this case, the controlling unit 110 may align the first to fifth associated contents in the order of the associated contents supporting the image of high image quality based on the image quality information of the first to fifth associated contents. That is, the controlling unit 110 may align the first to fifth associated contents in the order of the second associated contents supporting the image with 8K UHD image quality, the fourth associated contents supporting the image with 4K UHD image quality, the third and fifth associated contents supporting the image with HD image quality, and the first associated contents supporting the image with SD image quality. The first to fifth associated contents are aligned according to the above-mentioned image quality alignment conditions, such that the user may more rapidly perform a channel change to a channel providing the associated contents supporting the image of high quality among the associated contents associated with the image contents which are being currently watched.

Meanwhile, in the case in which at least two associated contents such as the third and fifth associated contents support an image of the same image quality, the controlling unit 110 may align the associated contents supporting the image of the same image quality in the order of the associated contents of an upper channel, or may align the associated contents supporting the image of the same image quality based on the broadcast time information of the associated contents.

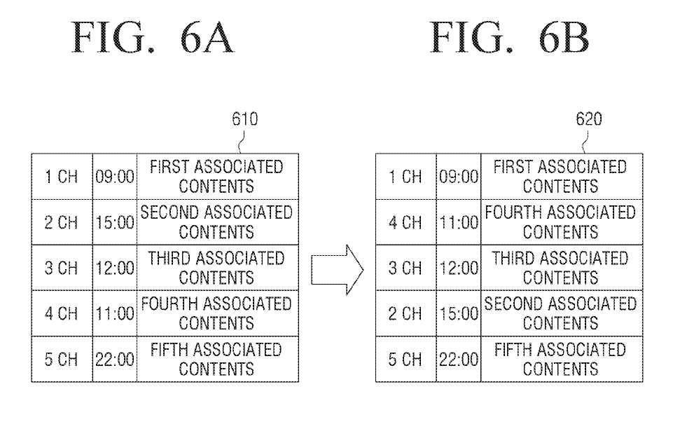

FIGS. 6A and 6B are diagrams illustrating a case in which the plurality of associated contents are aligned according to an alignment condition for a broadcast time in the broadcast receiving apparatus according to the exemplary embodiment.

An alignment list 610 illustrated in FIG. 6A illustrates a case in which the first to fifth associated contents searched with regard to the image contents which are being currently displayed are sequentially aligned from the upper channel, and an alignment list 620 illustrated in FIG. 6B illustrates a case in which the first to fifth associated contents are aligned according to the alignment condition for the broadcast time corresponding to the second category.

Specifically, the controlling unit 110 may search the first to fifth associated contents searched with regard to the image contents which are being currently displayed as contents associated with the image contents. Meanwhile, in the case in which the alignment condition is the alignment condition for the broadcast time corresponding to the second category, the controlling unit 110 aligns the first to fifth associated contents based on broadcast time information of the first to fifth associated contents which are searched.

For example, a broadcast start time of the first associated contents may be 9 A.M, a broadcast start time of the second associated contents may be 15 P.M, a broadcast start time of the third associated contents may be 12 A.M, a broadcast start time of the fourth associated contents may be 11 A.M, and a broadcast start time of the fifth associated contents may be 22 P.M.

In this case, the controlling unit 110 may align the first to fifth associated contents in the order of the broadcast start time based on the broadcast time information of the first to fifth associated contents. That is, the controlling unit 110 may align the first to fifth associated contents in the order of the first associated contents (9 A.M), the fourth associated contents (11 A.M), the third associated contents (12 A.M), the second associated contents (15 P.M), and the fifth associated contents (22 P.M).

The first to fifth associated contents are aligned according to the alignment condition for the broadcast time described above, such that the user may more easily select the associated contents watchable in the most suitable time zone for the user by taking into account the broadcast time of the associated contents aligned with regard to the image contents which are being currently watched, and perform a channel change to a channel providing the selected associated contents or sets a watching reservation or a reservation record for the corresponding associated contents.

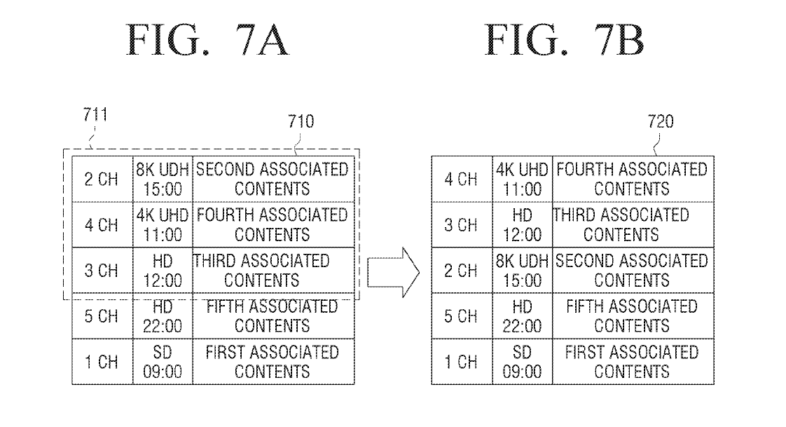

FIGS. 7A and 7B are diagrams illustrating a case in which the plurality of associated contents are aligned according to a complex alignment condition in the broadcast receiving apparatus according to the exemplary embodiment.

An alignment list 710 illustrated in FIG. 7A illustrates a case in which the first to fifth associated contents are aligned according to the image quality alignment condition corresponding to the first category, and an alignment list 720 illustrated in FIG. 7B illustrates a case in which the first to fifth associated contents are realigned according to the alignment condition for the broadcast time corresponding to the second category.

As described in FIGS. 5A and 5B, the controlling unit 110 aligns the first to fifth associated contents based on the image quality information of the first to fifth associated contents searched with regard to the image contents which are being currently displayed.

For example, the first associated contents may support the image with SD image quality, the second associated contents may support the image with 8K UHD image quality, the third and fifth associated contents may support the image with HD image quality, and the fourth associated contents may support the image with 4K UHD image quality. In this case, the controlling unit 110 may align the first to fifth associated contents in the order of the second associated contents supporting the image with 8K UHD image quality, the fourth associated contents supporting the image with 4K UHD image quality, the third and fifth associated contents supporting the image with HD image quality, and the first associated contents supporting the image with SD image quality. In the case in which the first to fifth associated contents are aligned according to the image quality alignment condition described above, the controlling unit 110 realigns the associated contents included in a preset priority based on the broadcast time information of the associated contents included in the preset priority among the first to fifth associated contents which are aligned.

As described above, the first to fifth associated contents may be aligned in the order of the second associated contents supporting the image with 8K UHD image quality, the fourth associated contents supporting the image with 4K UHD image quality, the third and fifth associated contents supporting the image with HD image quality, and the first associated contents supporting the image with SD image quality, according to the image quality alignment condition. Meanwhile, the associated contents included in the preset priority may be the second associated contents supporting the image with 8K UHD image quality, the fourth associated contents supporting the image with 4K UHD image quality, and the third associated contents supporting the image with HD image quality. In this case, the controlling unit 110 may realign the second, fourth, and third associated contents in the order of the broadcast start time based on the broadcast time information of the second, fourth, and the third associated contents included in the preset priority among the first to fifth associated contents.

For example, the broadcast start time of the second associated contents supporting the image of 8K UHD image quality may be 15 P.M, the broadcast start time of the fourth associated contents supporting the image of 4K UHD image quality may be 11 A.M, and the broadcast start time of the third associated contents supporting the image of HD image quality may be 12 A.M. In this case, the controlling unit 110 may realign the second, fourth, and the third associated contents included in the preset priority in the order of the fourth, third, and second associated contents.

As described above, the broadcast receiving apparatus 100 according to the embodiments aligns the plurality of associated contents searched with regard to the image contents which are being currently watched, based on the image quality and the broadcast time of the plurality of associated contents, whereby the user may more easily select the associated contents having excellent image quality and watchable in the most suitable time zone for the user.

Meanwhile, the embodiment is not limited thereto, and the controlling unit 110 may realign the first to fifth associated contents based on the image quality information of the associated contents included in the preset priority among the plurality associated contents which are aligned after aligning the plurality of associated contents according to the alignment condition for the broadcast time corresponding to the second category.

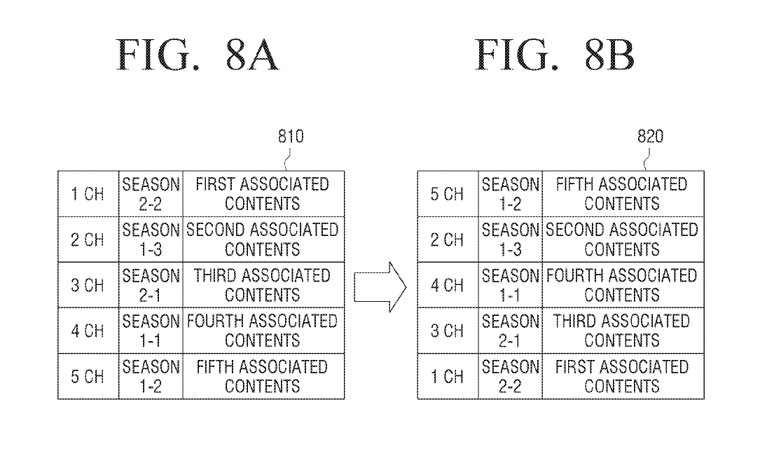

FIGS. 8A and 8B are first illustrative diagrams illustrating a case in which the plurality of associated contents associated with image contents of a serial form are aligned in the broadcast receiving apparatus according to the exemplary embodiment.

An alignment list 810 illustrated in FIG. 8A illustrates a case in which the first to fifth associated contents searched with regard to the image contents which are being currently displayed are sequentially aligned from the upper channel, and an alignment list 820 illustrated in FIG. 8B illustrates a case in which the first to fifth associated contents are aligned in the order of the associated contents included in the same group as the image contents which are being currently displayed.

Specifically, the controlling unit 110 may search the first to fifth associated contents searched with regard to the image contents which are being currently displayed as contents associated with the image contents. Meanwhile, the image contents which are being currently displayed may be the contents of the serial form such as the series or season. For example, in the case in which the image contents which are being currently displayed are second episode contents of a first season, the controlling unit 110 may set the associated contents belonging to the same season as the image contents among the first to fifth associated contents searched with regard to the image contents to an upper group, and may set the associated contents belonging to a different season from the image contents to a lower group. That is, the controlling unit 110 may set the second, fourth, and the fifth associated contents belonging to the first season which is the same as the image contents to the upper group, and may set the first and third associated contents to the lower group. Thereafter, the controlling unit 110 aligns the first to fifth associated contents in the order of a lower episode based on episode information of the associated contents included in the respective groups. Therefore, the controlling unit 110 may align the first to fifth associated contents searched with regard to the image contents in the order of the fourth, fifth, second, third, and first associated contents. In this case, the controlling unit 110 may determine the order of the associated contents belonging to the same group as the image contents based on the associated contents belonging to the same group as the image contents and the episode information of the image contents.

As illustrated, the upper group may include the second, fourth, and fifth associated contents, and among these, the fourth associated contents may be first episode contents of the first season. In this case, the controlling unit 110 may determine the fifth associated contents of the same episode as the image contents which are being displayed as the top priority, and may determine the fourth associated contents of an episode lower than the corresponding image contents as the lowest priority within the upper group.

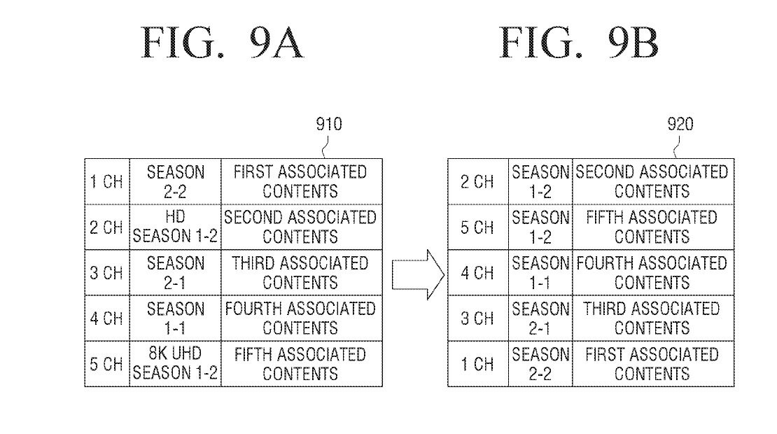

FIGS. 9A and 9B are second illustrative diagrams illustrating a case in which a plurality of associated contents associated with image contents of a serial form are aligned in a broadcast receiving apparatus according to another exemplary embodiment.

An alignment list 910 illustrated in FIG. 9A illustrates a case in which the first to fifth associated contents searched with regard to the image contents which are being currently displayed are sequentially aligned from the upper channel, and an alignment list 920 illustrated in FIG. 9B illustrates a case in which the first to fifth associated contents are aligned in the order of the associated contents included in the same group as the image contents which are being currently displayed.

As described above, the image contents which are being currently displayed may be the contents of the serial form such as the series or season, for example, second episode contents of the first season. In this case, the controlling unit 110 may set the second, fourth, and the fifth associated contents belonging to the first season which is the same as the image contents to the upper group, and may set the first and third associated contents to the lower group, among the first to fifth associated contents searched with regard to the image contents. Thereafter, the controlling unit 110 aligns the associated contents in the order of a lower episode based on episode information of the associated contents included in the respective groups. In this case, if the fourth associated contents among the associated contents included in the upper group are the contents having a lower episode than the image contents, the controlling unit 110 determines the fourth associated contents as the lowest priority within the upper group.

Therefore, the controlling unit 110 may align the first to fifth associated contents associated with the image contents in the order of the second, fifth, fourth, third, and first associated contents. As such, in the state in which the first to fifth associated contents are aligned, if at least two associated contents have the same episode, the controlling unit 110 may align the first to fifth associated contents in the order of the associated contents having excellent image quality based on the image quality information of at least two associated contents having the same episode. As illustrated, in the case in which the second and fifth associated contents have the same episode, the controlling unit 110 determines the second associated contents having excellent image quality as a higher priority than the fifth associated contents using the image quality information of the second and fifth associated contents having the same episode. For example, the second associated contents may provide the image of HD image quality and the fifth associated contents may provide the image of 8K UHD image quality. In this case, the controlling unit 110 may determine that the fifth associated contents have more excellent image quality than that of the second associated contents, and may determine the fifth associated contents as the higher priority than the second associated contents.

However, the embodiment is not limited thereto, and if at least two associated contents have the same episode in the state in which the first to the fifth associated contents are aligned, the controlling unit 110 may determine the associated contents having the fastest broadcast time as the top priority based on the broadcast time information of at least two associated contents.

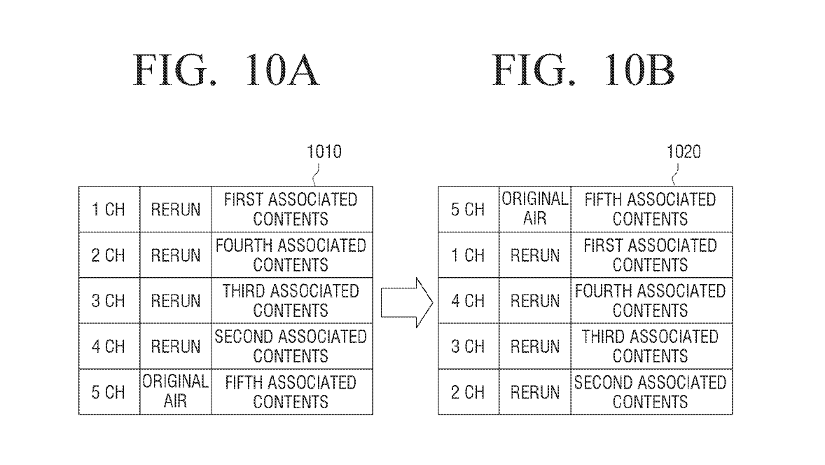

FIGS. 10A and 10B are diagrams illustrating a case in which the plurality of associated contents are aligned according to an organization type condition in the broadcast receiving apparatus according to the exemplary embodiment.

An alignment list 1010 illustrated in FIG. 10A illustrates a case in which the first to fifth associated contents are aligned according to the alignment condition for the broadcast time. However, the embodiment is not limited thereto, and the alignment list 1010 illustrated in FIG. 10A may be the case in which the first to fifth associated contents are aligned according to the image quality condition. In addition, an alignment list 1020 illustrated in FIG. 10B illustrates a case in which the first to fifth associated contents are realigned based on the organization type information of the first to fifth associated contents.

As in the example described above, the broadcast start time of the first associated contents may be 9 A.M, the broadcast start time of the second associated contents may be 15 P.M, the broadcast start time of the third associated contents may be 12 A.M, the broadcast start time of the fourth associated contents may be 11 A.M, and the broadcast start time of the fifth associated contents may be 22 P.M. In this case, the controlling unit 110 may align the first to fifth associated contents in the order of the broadcast start time based on the broadcast time information of the first to fifth associated contents. That is, the controlling unit 110 may align the first to fifth associated contents in the order of the first associated contents (9 A.M), the fourth associated contents (11 A.M), the third associated contents (12 A.M), the second associated contents (15 P.M), and the fifth associated contents (22 P.M).

In the case in which the first to fifth associated contents are aligned according to the alignment condition for the broadcast time as described above, the controlling unit 110 realigns the first to fifth associated contents base on the organization type information of the first to fifth associated contents. For example, the fifth associated contents among the first to fifth associated contents may be the contents which are originally broadcasted with regard to the image contents which are being currently displayed, and the rest of the associated contents may be the contents which are rerun with regard to the corresponding image contents. In this case, the controlling unit 110 determines the fifth associated contents corresponding to the original air as the top priority. Therefore, the controlling unit 110 may realign the first to fifth associated contents in the order of the fifth associated contents (22 P.M) corresponding to the original air, the first associated contents (9 A.M), the fourth associated contents (11 A.M), the third associated contents (12 A.M), and the second associated contents (15 P.M).

Hereinafter, a method for providing a contents recommendation service in the broadcast receiving apparatus 100 according to the embodiment will be described in detail.

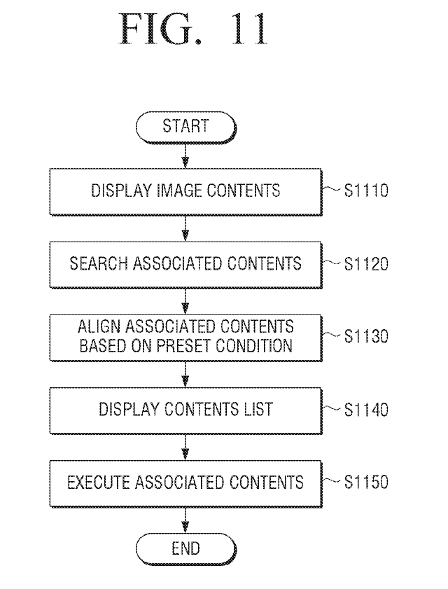

FIG. 11 is a flow chart of a method for providing a contents recommendation service in a broadcast receiving apparatus according to an exemplary embodiment.

As illustrated in FIG. 11, the broadcast receiving apparatus 100 displays the image contents on the screen (S1110). Here, the image contents may be at least one of contents provided from a channel selected according to a user request, contents supplied by a video on demand (VOD) operator, contents pre-stored in the broadcast receiving apparatus 100, and contents received from other terminals. In a state in which the above-mentioned image contents are displayed, if a contents search service related user instruction is input, the broadcast receiving apparatus 100 searches associated contents associated with image contents which are being currently displayed, based on image quality information and broadcast time information included in pre-stored contents information for each of a plurality of channels (S1120). Here, the contents information, which is an electronic program guide (EPG), may include at least one of image quality information and broadcast time information for image contents provided to each of the channel as well as title information, episode information, channel information, and pay information of the corresponding image contents.

Thereafter, the broadcast receiving apparatus 100 aligns the plurality of associated contents based on at least one of image quality information and broadcast time information of the plurality of associated contents searched with regard to the image contents based on a preset condition (S1030 and S1130).

Hereinafter, a method for aligning the plurality of associated contents searched with regard to the image contents based on the preset condition in the broadcast receiving apparatus 100 according to the embodiment will be described in detail.

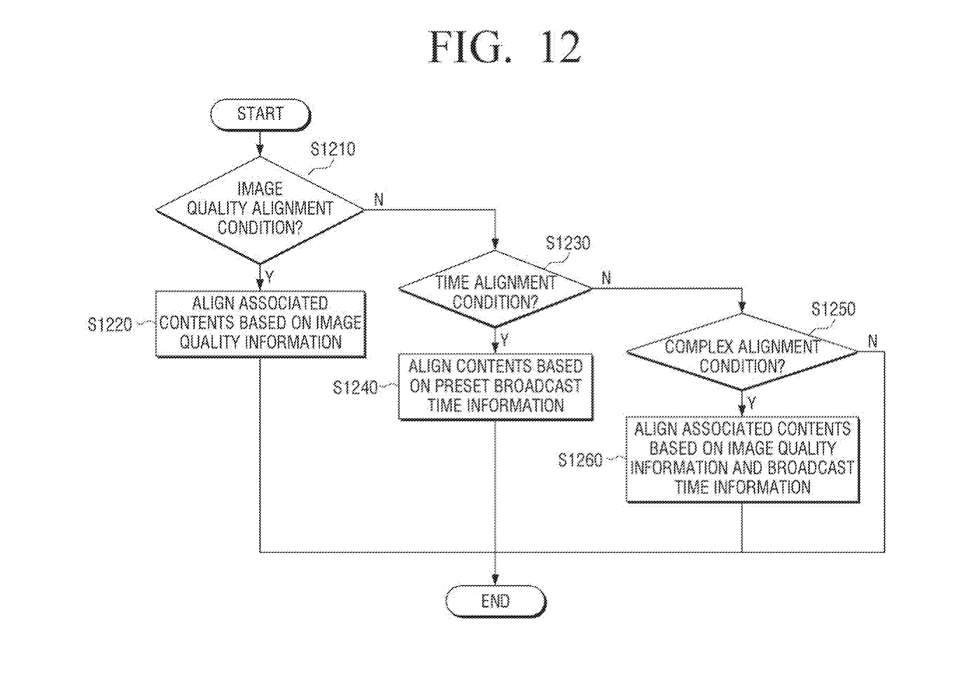

FIG. 12 is a flow chart of a method for aligning a plurality of associated contents which are pre-searched in a broadcast receiving apparatus according to an exemplary embodiment.

As illustrated in FIG. 12, the broadcast receiving apparatus 100 aligns the plurality of associated contents which are pre-searched with regard to the image contents which are being currently displayed, according to the preset condition. Specifically, the broadcast receiving apparatus 100 determines whether or not the preset condition is the image quality alignment condition (S1210). As the determination result, in the case in which the preset condition is the image quality alignment condition, the broadcast receiving apparatus 100 may perform the alignment for the plurality of associated contents based on the following exemplary embodiments.

According to an exemplary embodiment, in the case in which the alignment condition for image quality is preset, the broadcast receiving apparatus 100 aligns the plurality of associated contents in the order of high image quality, based on image quality information of the plurality of associated contents pre-searched with regard to the image contents (S1220).

For example, first associated contents searched with regard to the image contents may support an image with UHD image quality, second associated contents may support an image with HD image quality, and third associated contents may support an image with SD image quality. In this case, the broadcast receiving apparatus 100 may sequentially align the plurality of associated contents from the first associated contents having the most excellent image quality.

However, the embodiment is not limited thereto, and the image quality information described above may be one of depth information and screen ratio information. In this case, the broadcast receiving apparatus 100 may align the plurality of associated contents in the order of the associated contents having the excellent image quality based on the depth information or the screen ratio information of the plurality of associated contents.

According to another exemplary embodiment, in the case in which an alignment condition for a broadcast time is preset, the broadcast receiving apparatus 100 may align the plurality of associated contents in the order of the associated contents having a fast reproduction time on the basis of a current reproduction time of the image contents which are being currently displayed, based on broadcast time information of the plurality of associated contents pre-searched with regard to the image contents (S1230 and S1240).

For example, the first associated contents searched with regard to the image contents may be provided at 9 A.M, and the second and third associated contents may be provided at 3 P.M and 4 P.M, respectively. In this case, the broadcast receiving apparatus 100 may sequentially align the plurality of associated contents from the first associated contents having the most fast reproduction time.

Meanwhile, the broadcast receiving apparatus 100 may determine the first associated contents as top priority depending on whether or not a total of reproduction time in which the first associated contents are reproduced is within a preset reference time range, in the case in which the first associated contents among the plurality of associated contents are being reproduced in aligning the plurality of associated contents based on the broadcast time information of the plurality of associated contents.

For example, the preset reference time may be ten minutes. In this case, the broadcast receiving apparatus 100 may determine the first associated contents as the top priority, in the case in which a reproduced time of the first associated contents which are being currently reproduced is the preset reference time or less. Meanwhile, in the case in which the reproduced time of the first associated contents which are being currently reproduced exceeds the preset reference time, the broadcast receiving apparatus 100 may determine the first associated contents as the lowest priority, or may align the plurality of associated contents based on the broadcast time information of other associated contents except for the first associated contents.

However, the embodiment is not limited thereto, but the broadcast receiving apparatus 100 may compare the reproduction time of the first associated contents which are being currently reproduced among the plurality of associated contents with a total of reproduction time in which the image contents which are being currently reproduced are reproduced, and may determine the first associated contents as the top priority depending on the comparison result. Specifically, in the case in which it is determined that the first associated contents which are being currently reproduced are reproduced at the same timing as the image contents or are reproduced at a timing later than the image contents, the broadcast receiving apparatus 100 determines the first associated contents as the top priority. Meanwhile, in the case in which it is determined that the first associated contents which are being currently reproduced are reproduced at a timing earlier than the corresponding image contents, the broadcast receiving apparatus 100 may determine the first associated contents as the lowest priority, or may align the plurality of associated contents based on the broadcast time information of other associated contents except for the first associated contents.

Meanwhile, in the case in which the preset condition is the complex alignment condition, the broadcast receiving apparatus 100 aligns the plurality of associated contents based on the image quality information and the broadcast time information for each of the plurality of associated contents which are pre-searched (S1250 and S1260).

Specifically, in the case in which the preset condition is the complex alignment condition, the broadcast receiving apparatus 100 aligns the plurality of associated contents in the order of the associated contents of high image quality, based on the image quality information on each of the plurality of associated contents which are pre-searched with regard to the image contents which are being displayed. Thereafter, the broadcast receiving apparatus 100 may realign the associated contents included in a preset priority based on broadcast time information of the associated contents included in the preset priority among the plurality of associated contents which are aligned in the order of the high image quality.

Hereinafter, in the case in which a lower alignment condition with regard to the time alignment condition is set in the operation (S1230) described above, a method for aligning the plurality of associated contents which are pre-searched, based on the lower alignment condition will be described in detail.

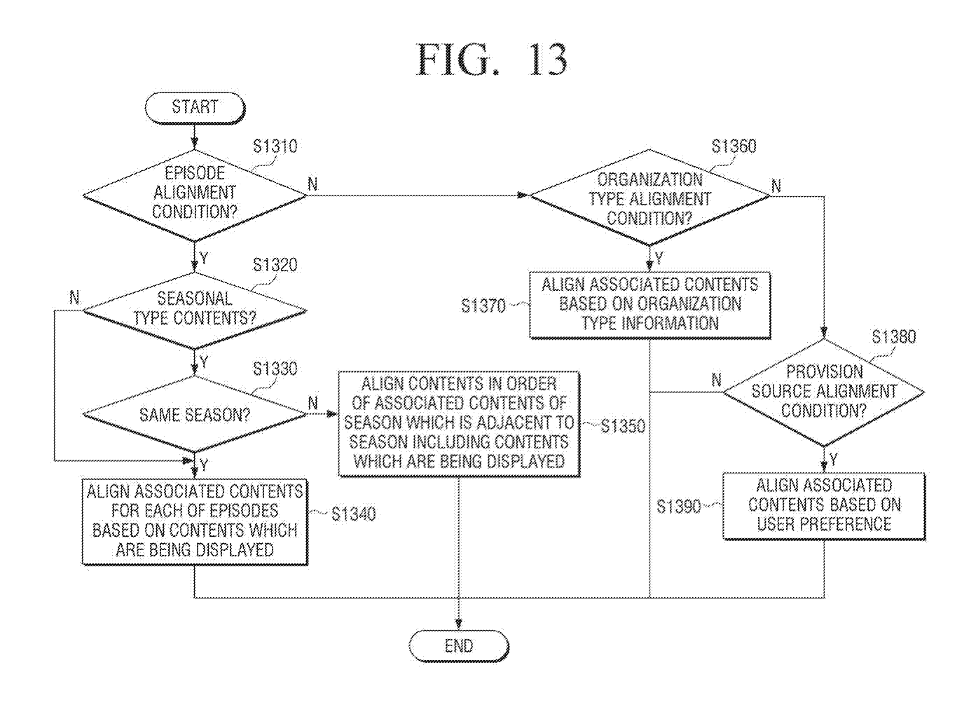

FIG. 13 is a flow chart of a method for aligning the plurality of associated contents which are pre-searched according to the time alignment condition in the broadcast receiving apparatus according to an exemplary embodiment.

As illustrated in FIG. 13, in the case in which the preset condition is the time alignment condition, the broadcast receiving apparatus 100 determines whether a lower alignment condition which is currently set among a plurality of lower alignment conditions associated with the time alignment condition is an episode alignment condition (S1310). As the determination result, in the case in which the lower alignment condition is the episode alignment condition, the broadcast receiving apparatus 100 determines whether or not the image contents which are being displayed are a seasonal type of contents (S1320).

As the determination result, in the case in which it is determined that the image contents which are being displayed are contents for each of the episodes and are not the seasonal type of contents, the broadcast receiving apparatus 100 aligns the associated contents for each of the episodes based on the image contents which are being displayed through an operation (S1340) to be described below. That is, in the case in which it is determined that the image contents which are being displayed are contents for each of the episodes and are not the seasonal type of contents, the broadcast receiving apparatus 100 may align the plurality of associated contents in the order of a low episode based on episode information corresponding to each of the plurality of associated contents which are pre-searched with regard to the image contents.

However, the embodiment is not limited thereto, and in the case in which it is determined that the image contents which are being displayed are contents for each of the episodes and are not the seasonal type of contents, the broadcast receiving apparatus 100 may align the plurality of associated contents by determining the associated contents of the same episode as the image contents as the top priority and determining the associated contents belonging to a low episode among other associated contents as a next priority, based on episode information corresponding to the image contents and the plurality of associated contents which are pre-searched, respectively.

Meanwhile, in the case in which the image contents are a serial type of contents such as the season in the operation (S1320), the broadcast receiving apparatus 100 determines whether or not the plurality of associated contents pre-searched with regard to the image contents belong to the same season as the image contents (S1330). As the determination result, in the case in which it is determined that the plurality of associated contents belong to the same season as the image contents, the broadcast receiving apparatus 100 aligns the plurality of associated contents in the order of the low episode based on the episode information corresponding to each of the plurality of associated contents pre-searched with regard to the image contents (S1340).

However, the embodiment is not limited thereto, and in the case in which it is determined that the plurality of associated contents belong to the same season as the image contents, the broadcast receiving apparatus 100 may align the plurality of associated contents by determining the associated contents of the same episode as the image contents as the top priority and determining the associated contents belonging to a low episode among other associated contents as a next priority, based on episode information corresponding to the image contents and the plurality of associated contents which are pre-searched, respectively.

Meanwhile, in the case in which it is determined that the plurality of associated contents pre-searched with regard to the image contents belong to a different season from the image contents in the operation (S1330), the broadcast receiving apparatus 100 aligns the plurality of associated contents in the order of the associated contents belonging to a season which is adjacent to the season to which the image contents belong, among the plurality of associated contents (S1350).

However, the embodiment is not limited thereto. For example, at least one of the plurality of associated contents pre-searched with regard to the image contents may belong to the same season as the image contents, and the rest of the plurality of associated contents may belong to the different season from the image contents. In this case, the broadcast receiving apparatus 100 may align the plurality of associated contents by determining the associated contents belonging to the same season as the image contents as the top priority and determining the associated contents belonging to the season which is adjacent to the season to which the image contents belong, among the rest of the associated contents as the next priority.

According to another exemplary embodiment, in the case in which a complex alignment condition for image quality and broadcast time is preset, the broadcast receiving apparatus 100 may align the plurality of associated contents in the order of the associated contents of high image quality, based on image quality information on each of the plurality of associated contents pre-searched with regard to the image contents which are being displayed. Thereafter, the broadcast receiving apparatus 100 may realign the associated contents included in a preset priority based on broadcast time information of the associated contents included in the preset priority among the plurality of associated contents which are aligned in the order of the high image quality.

According to another exemplary embodiment, the broadcast receiving apparatus 100 may align the plurality of associated contents pre-searched with regard to the image contents depending on whether or not the corresponding image contents which are being currently displayed are the serial type contents. Specifically, in the case in which the image contents which are being currently displayed are the serial type contents such as the series or season, the broadcast receiving apparatus 100 searches the associated contents included in the same group as the image contents which are being displayed among the plurality of contents. As the search result, in the case in which the associated contents included in the same group as the corresponding image contents are searched, the broadcast receiving apparatus 100 aligns the plurality of associated contents in the order of the associated contents included in the same group as the image contents. Meanwhile, in the case in which the associated contents included in the same group as the corresponding image contents are not searched, the broadcast receiving apparatus 100 aligns the plurality of associated contents in the order of the associated contents belonging to an upper group or a lower group on the basis of the group including the image contents.

Meanwhile, in the case in which a lower alignment condition which is currently set among a plurality of lower alignment conditions associated with the time alignment condition is the organization type alignment condition, the broadcast receiving apparatus 100 aligns the plurality of associated contents based on organization type information corresponding to each of the plurality of associated contents which are pre-searched with regard to the image contents (S1360 and S1370). Meanwhile, the broadcast receiving apparatus 100 may realign the plurality of associated contents which are aligned according to the various exemplary embodiments described above.

According to the exemplary embodiment, the broadcast receiving apparatus 100 may realign the plurality of associated contents which are pre-aligned, based on the organization type information of the plurality of associated contents. Here, the organization type information may include at least one of a live broadcast, an original air, and a rerun. For example, in a state in which the plurality of associated contents are aligned in the order of the first, second, and third associated contents, the first and second associated contents may be contents provided as the rerun, and the third associated contents may be contents provided as the original air. In this case, the broadcast receiving apparatus 100 may determine the third associated contents, which are the original air, as the top priority, and may realign the plurality of associated contents in the order of the third, first, and second associated contents based on the above-mentioned determination.

Meanwhile, in the case in which a lower alignment condition which is currently set among a plurality of lower alignment conditions associated with the time alignment condition is the provision source alignment condition, the broadcast receiving apparatus 100 aligns the plurality of associated contents pre-searched with regard to the image contents based on user preference (S1380 and S1390).

Meanwhile, in the case in which associated contents which are set to a pay service are present in the plurality of associated contents pre-searched with regard to the image contents which are being currently displayed, the broadcast receiving apparatus 100 may obtain the rest of the plurality of associated contents except for the associated contents which are set to the pay service among the plurality of associated contents and may align the plurality of associated contents based on at least one of the image quality information and the broadcast time information of the rest of the plurality of associated contents which are obtained.

As another example, the broadcast receiving apparatus 100 may align the plurality of associated contents in the order of the associated contents of a favorite watching channel of the user among the plurality of associated contents pre-searched with regard to the image contents which are being displayed, according to the provision source alignment condition.

Referring to again FIG. 11, in the case in which the plurality of associated contents pre-searched with regard to the image contents which are being currently displayed are aligned by the various alignment conditions described above, the broadcast receiving apparatus 100 generates a contents list for the plurality of associated contents which are aligned (S1140). Here, the contents list includes thumbnail images for identifying each of the plurality of associated contents aligned by the various alignment conditions described above. The above-mentioned thumbnail images may include at least one of image quality information, broadcast time information, title information, episode information, channel information, and pay information for each of the plurality of associated contents. Therefore, the broadcast receiving apparatus 100 may display the contents list including the thumbnail images corresponding to each of the plurality of associated contents associated with the image contents which are being currently displayed, on one region of a screen.

Thereafter, in a state in which the contents list is displayed, if one of a plurality of thumbnail images included in the contents list is selected, the broadcast receiving apparatus 100 executes the associated contents corresponding to the selected thumbnail image (S1150).

Specifically, in the case in which one thumbnail image is selected, the broadcast receiving apparatus 100 compares a broadcast time of the associated contents corresponding to the selected thumbnail image with a current time to determine whether or not the associated contents corresponding to the selected thumbnail image may be watched. As the determination result, in the case in which the associated contents corresponding to the selected thumbnail image may be watched, the broadcast receiving apparatus 100 performs a channel change to a channel of the associated contents corresponding to the selected thumbnail image and displays the associated contents corresponding to the thumbnail image selected by the user. Meanwhile, in the case in which the associated contents corresponding to the selected thumbnail image may not be watched, the broadcast receiving apparatus 100 may execute at least one of a reservation watch and a reservation record for the associated contents corresponding to a pre-selected thumbnail image based on a user instruction. Specifically, the associated contents corresponding to the selected thumbnail image may be a broadcast schedule contents provided at a time later than a current time. In this case, the broadcast receiving apparatus 100 generates a pop-up message guiding that the associated contents corresponding to the selected thumbnail image are the broadcast schedule contents, and displays the generated pop-up message. If an execution instruction for the corresponding associated contents is input in a state in which the above-mentioned pop-up message is displayed, the broadcast receiving apparatus 100 performs at least one of the watching reservation and the reservation record for the associated contents, which are the broadcast schedule contents, based on the input execution instruction.

According to the exemplary embodiments, the broadcast receiving apparatus may provide various digital broadcast services to the user. Further, the broadcast receiving apparatus according to the embodiments may increase convenience for the selection of the channel providing the associated contents associated with the image contents which are being currently displayed.

Hereinabove, the embodiments have been described with reference to the exemplary embodiments thereof.

Although the exemplary embodiments have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the embodiments.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method for providing a contents recommendation service of a broadcast receiving apparatus, the method comprising:
displaying image contents;
searching a plurality of associated contents associated with image contents, according to a user instruction;
aligning the plurality of associated contents based on at least one of image quality information and broadcast time information of the plurality of associated contents; and
displaying a contents list for the plurality of associated contents which are aligned.

2. The method as claimed in claim 1, wherein in the aligning the plurality of associated contents, when an alignment condition is an alignment condition for image quality, the plurality of associated contents are aligned in an order of the associated contents of image quality based on the image quality information of the associated contents.

3. The method as claimed in claim 1, wherein in the aligning the plurality of associated contents, when an alignment condition is an alignment condition for broadcast time, the plurality of associated contents are aligned in an order of the associated contents having an earlier reproduction time than a current reproduction time of the image contents based on broadcast time information of the associated contents.

4. The method as claimed in claim 3, wherein in the aligning the plurality of associated contents, when first associated contents among the plurality of associated contents are being reproduced, the first associated contents are determined as a top priority when a total reproduction time in which the first associated contents are reproduced is within a preset reference time.

5. The method as claimed in claim 1, wherein in the aligning the plurality of associated contents, when an alignment condition is a complex alignment condition, the plurality of associated contents are aligned in an order of the associated contents of high image quality based on the image quality information and the associated contents included in a preset priority are realigned based on the broadcast time information of the associated contents included in the preset priority among the plurality of associated contents which are aligned.

6. The method as claimed in claim 1, wherein in the aligning the plurality of associated contents,
when the image contents are a serial type of contents, the associated contents included in a same group as the image contents among the plurality of associated contents are searched, and when the associated contents included in the same group as the image contents are searched, the plurality of associated contents are aligned in an order of the associated contents included in the same group as the image contents, and
when the associated contents included in the same group as the image contents are not searched, the plurality of associated contents are aligned in the order of the associated contents belonging to one of a first group and a second group, lower than the first group on a basis of the same group including the image contents.

7. The method as claimed in claim 1, wherein in the operation of aligning the plurality of associated contents,
the plurality of associated contents which are aligned are realigned based on organization type information of the plurality of associated contents, and
the organization type information includes at least one of a live broadcast, an original airing, and a rerun.

8. The method as claimed in claim 1, wherein in the operation of aligning the plurality of associated contents,
the plurality of associated contents are aligned based on at least one of the image quality information and the broadcast time information of a rest of the plurality of associated contents except for associated contents which are set to a pay service, among the plurality of associated contents.

9. The method as claimed in claim 1, wherein the contents list includes thumbnail images for identifying each of the plurality of associated contents which are aligned, and
the thumbnail images each include at least one of the image quality information, the broadcast time information, title information, episode information, channel information, and pay information of the associated contents.

10. The method as claimed in claim 9, further comprising executing associated contents corresponding to a selected thumbnail image when one of a plurality of thumbnail images included in the contents list is selected,
wherein in executing associated contents,
a broadcast time of the associated contents corresponding to the selected thumbnail image is compared with a current time to determine whether t the associated contents corresponding to the selected thumbnail image are watchable,
when the associated contents corresponding to the selected thumbnail image are watchable, a channel change to a channel of the associated contents corresponding to the selected thumbnail image is performed, and
when the associated contents corresponding to the selected thumbnail image are not watchable, at least one of a reservation watch and a reservation record for the associated contents corresponding to the selected thumbnail image is executed based on the user instruction.

11. A broadcast receiving apparatus, comprising:
a display unit configured to display image contents: and
a controlling unit configured to control the display unit where a plurality of associated contents associated with the image contents are searched according to a user instruction, the plurality of associated contents are aligned based on at least one of image quality information and broadcast time information of the plurality of associated contents which are searched, and a contents list for the plurality of associated contents which are aligned is displayed.

12. The broadcast receiving apparatus as claimed in claim 11, wherein in the case in when an alignment condition is an alignment condition for image quality, the controlling unit aligns the plurality of associated contents in the order of the associated contents of high image quality based on the image quality information of the associated contents.

13. The broadcast receiving apparatus as claimed in claim 11, wherein when an alignment condition is an alignment condition for a broadcast time, the controlling unit aligns the plurality of associated contents in an order of the associated contents having an earlier reproduction time than a current reproduction time of the image contents based on the broadcast time information of the associated contents.

14. The broadcast receiving apparatus as claimed in claim 13, wherein when first associated contents among the plurality of associated contents are being reproduced, the controlling unit determines the first associated contents as a top priority when a total reproduction time in which the first associated contents are reproduced is within a preset reference time.

15. The broadcast receiving apparatus as claimed in claim 11, wherein when an alignment condition is a complex alignment condition, the controlling unit aligns the plurality of associated contents in an order of the associated contents of high image quality based on the image quality information, and realigns the associated contents included in a preset priority based on the broadcast time information of the associated contents included in the preset priority among the plurality of associated contents which are aligned.

16. The broadcast receiving apparatus as claimed in claim 11, wherein when the image contents are a serial type of contents, the controlling unit searches the associated contents included in a same group as the image contents among the plurality of associated contents and aligns the plurality of associated contents in an order of the associated contents included in the same group as the image contents when the associated contents included in the same group as the image contents are searched, and
aligns the plurality of associated contents in the order of the associated contents belonging to one of a first group and a second group, lower than the first group, on the basis of the same group including the image contents if the associated contents included in the same group as the image contents are not searched.

17. The broadcast receiving apparatus as claimed in claim 11, wherein the controlling unit realigns the plurality of associated contents which are aligned, based on organization type information of the plurality of associated contents, and
the organization type information includes at least one of a live broadcast, an original airing, and a rerun.

18. The broadcast receiving apparatus as claimed in claim 11, wherein the controlling unit aligns the plurality of associated contents based on at least one of the image quality information and the broadcast time information of a rest of the plurality of associated contents except for associated contents which are set to a pay service, among the plurality of associated contents.

19. The broadcast receiving apparatus as claimed in claim 11, wherein the contents list includes thumbnail images for identifying each of the plurality of associated contents which are aligned, and
the thumbnail images each include at least one of the image quality information, the broadcast time information, title information, episode information, channel information, and pay information of the associated contents.

20. The broadcast receiving apparatus as claimed in claim 19, wherein when one of a plurality of thumbnail images included in the contents list is selected, the controlling unit compares a broadcast time of the associated contents corresponding to a selected thumbnail image with a current time to determine whether the associated contents corresponding to the selected thumbnail image are watchable,
performs a channel change to a channel of the associated contents corresponding to the selected thumbnail image, when the associated contents corresponding to the selected thumbnail image are watchable, and
executes at least one of a reservation watch and a reservation record for the associated contents corresponding to the selected thumbnail image based on the user instruction, when the associated contents corresponding to the selected thumbnail image are not watchable.
